(19) United States
(12) Patent Application Publication
(10) Pub. No.: US 2018/0231500 A1
(43) Pub. Date: Aug. 16, 2018

(54) SYSTEMS AND METHODS FOR INSPECTING CYLINDRICAL MEMBERS

(71) Applicant: General Electric Company, Schenectady, NY (US)

(72) Inventors: Kurt Neal Laurer, Saratoga Springs, NY (US); John Matthew Sassatelli, Valley Falls, NY (US); Francis Alexander Reed, Duanesburg, NY (US); Robert William Bergman, Scotia, NY (US); Paul Howard Davidson, Albany, NY (US); August Elwood Pendergast, Greenfield Center, NY (US); Thomas Earnest Moldenhauer, Burnt Hills, NY (US); Michael Charles Freda, Long Beach Township, NJ (US); Robert Charles Malison, Schenectady, NY (US); Paul Michael Kienitz, Ely, MN (US); Collin Daniel Mooney, Voorheesville, NY (US); Paul James Martino, Schenectady, NY (US); William Bartholomew, Cobleskill, NY (US)

(21) Appl. No.: 15/434,663

(22) Filed: Feb. 16, 2017

(51) Int. Cl. G01N 29/04; G01N 29/28; G01M 15/14

(52) U.S. Cl. CPC G01N 29/043; G01M 15/14; G01N 29/28

(57) ABSTRACT

An inspection system for a cylindrical member includes at least one retention member positionable about at least a portion of a circumference of the cylindrical member. The inspection system also includes a positioning system and at least one housing. The at least one housing is coupleable to the at least one retention member at each of a series of circumferential inspection locations. The at least one housing includes at least one probe. The positioning system cooperates with the at least one retention member to position the at least one probe at each of the circumferential locations. The at least one probe is configured to send and receive a signal through an interior of the cylindrical member.

### BACKGROUND

The field of this disclosure relates generally to inspection systems and, more particularly, to systems for use in inspecting cylindrical members, such as but not limited to shafts.

At least some cylindrical members, such as but not limited to rotor shafts, require inspections to identify incipient structural defects. For example, because of their exposure to high temperatures and/or pressures, inspection of turbine rotor components and shafts is necessary to ensure these components remain operational for the duration of their expected useful life. At least some inspections of components have been performed by coupling at least one inspection probe to an outer surface of the component, and then manually manipulating and positioning the at least one inspection probe to scan the component to identify structurally weakened areas. For example, a single inspection probe is used in a pulse-echo configuration, in which the inspection probe transmits a signal into the component and receives a reflected signal from a discontinuity or other structurally weakened area within the component. For another example, at least two inspection probes are used in a pitch-catch configuration, in which one probe transmits a signal into the component, and another probe is positioned to receive a reflected signal from a discontinuity or other structurally weakened area within the component.

Inspections using such systems may be time consuming and laborious. For example, manual manipulation and positioning of the probes may require a significant amount of time due to the small positional increments that are required to scan the component. Depending on the type of inspection and the inspection apparatus, the positional accuracy required between probes for the movement may be as small as thousandths of an inch. Although moving the system for such a short distance may not be difficult, accumulation of small positioning errors over each of a series of moves may create issues when moving the system by hand or when using a non-rigid inspection system.

### BRIEF DESCRIPTION

In one aspect, an inspection system for a cylindrical member is provided. The inspection system includes at least one retention member positionable about at least a portion of a circumference of the cylindrical member. The inspection system also includes a positioning system and at least one housing. The at least one housing is coupleable to the at least one retention member at each of a series of circumferential inspection locations. The at least one housing includes at least one probe. The positioning system cooperates with the at least one retention member to position the at least one probe at each of the circumferential locations. The at least one probe is configured to send and receive a signal through an interior of the cylindrical member.

In another aspect, a method of inspecting a cylindrical member is provided. The method includes positioning at least one retention member about at least a portion of a circumference of the cylindrical member, and coupling at least one housing to the at least one retention member. The at least one housing includes at least one probe. The method also includes positioning the at least one housing at a series of circumferential inspection locations along the retention member, and activating the at least one probe at each of the circumferential inspection locations to send and receive a signal through an interior of the cylindrical member.

### BRIEF DESCRIPTION OF THE DRAWINGS

FIG. 1 is a schematic illustration of an exemplary power plant;

FIG. 2 is a schematic illustration of an exemplary first embodiment of an inspection system for use in inspecting a cylindrical member, such as a rotor shaft of the power plant shown in FIG. 1;

FIG. 3 is a schematic illustration of the inspection system shown in FIG. 2, in a view taken along an axis of the cylindrical member;

FIG. 4 is a schematic illustration of an exemplary second embodiment of the inspection system for use in inspecting a cylindrical member, such as the rotor shaft of the power plant shown in FIG. 1;

FIG. 5 is a schematic illustration of the inspection system shown in FIG. 4, in a view taken along an axis of the cylindrical member; and

FIG. 6 is a flow diagram of an exemplary method of inspecting a cylindrical member, such as the rotor shaft of the power plant shown in FIG. 1.

### DETAILED DESCRIPTION

The following detailed description illustrates inspection systems and methods for cylindrical members by way of example and not by way of limitation. Exemplary inspection systems are described herein as being useful for inspecting turbine rotor shafts. However, it is contemplated that the shaft inspection systems and methods have general application to a broad range of inspection systems for cylindrical members used in a variety of fields other than only such turbines, such as but not limited to rolling members used in paper manufacturing or steel manufacturing.

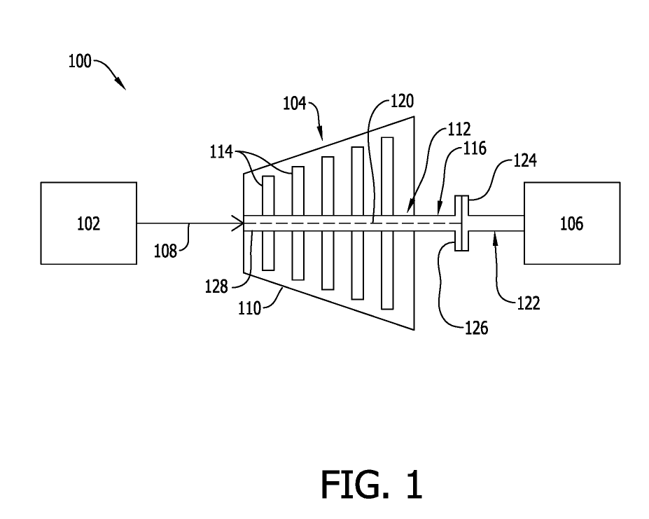

FIG. 1 illustrates an exemplary power plant 100. In the exemplary embodiment, power plant 100 includes a steam generator 102, a turbine 104, and an electrical generator 106. Steam generator 102 boils water to generate steam 108, and steam 108 is channeled through turbine 104. Turbine 104 includes a turbine casing 110 and a rotor 112 positioned at least in part within turbine casing 110. Rotor 112 includes a plurality of blades 114 coupled to a rotor shaft 116. Rotor shaft 116 includes a shaft outer surface 128. An axis 120 extends longitudinally through shaft 116. In the exemplary embodiment, generator 106 includes a drive shaft 122 including a drive shaft flange 124, and rotor shaft 116 of turbine 104 also includes a flange 126 removably coupled (e.g., bolted) to drive shaft flange 124. Moreover, in some embodiments, power plant 100 may also include a gas turbine assembly (not shown) that channels exhaust to steam generator 102 for heating steam generator 102, and that may provide shaft power to another electrical generator (not shown).

During operation of power plant 100, steam 108 flowing through turbine 104 impinges rotor blades 114 or buckets and causes rotor 112 to rotate (i.e., causes rotor blades 114 and rotor shaft 116 to rotate). Rotation of rotor 112 causes generator drive shaft 122 to rotate, thus, enabling generator 106 to generate electricity. Rotor 112 generally is subjected to high levels of thermal and mechanical stresses during operation. As such, it is commonplace to periodically test the structural integrity of rotor 112 by inspecting the coupling of rotor blades 114 to rotor shaft 116, and/or by inspecting the structural continuity of an interior of rotor shaft 116 using, for example, at least one probe (not shown) coupled to rotor shaft 116 on shaft outer surface 128. However, shaft outer surface 128 may include steps or other contours, and/or rotor 112 may have other design features along shaft 116, such as rotor wheels and/or seals, that make it difficult to position such probes in a location that provides a clear internal signal path to each region of interest within rotor shaft 116. As such, the inspection system disclosed herein is configured to securely, accurately, and relatively quickly position such probes relative to shaft outer surface 128 at a plurality of circumferential positions at each accessible axial station of rotor shaft 116.

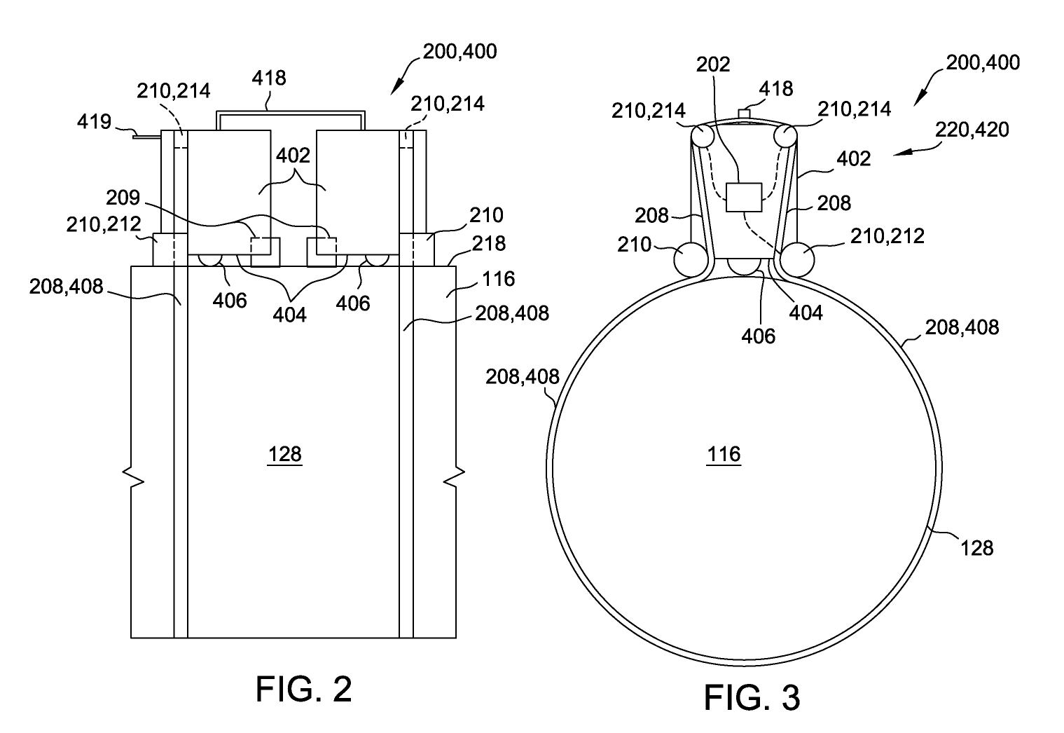

FIG. 2 is a schematic illustration of a first embodiment 200 of an inspection system 400 that may be used to inspect a cylindrical member. More specifically, FIG. 2 illustrates a side view of rotor shaft 116 having system 400 coupled thereto. FIG. 3 is a schematic illustration of first embodiment 200 of inspection system 400 taken along axis 120 (shown in FIG. 1) of shaft 116. In the exemplary embodiment, prior to coupling inspection system 400 to rotor 112, rotor 112 (e.g., blades 114 and shaft 116) is initially removed from turbine casing 110 (shown in FIG. 1) and mounted on a frame (not shown). In other embodiments, inspection system 400 may be used to inspect rotor shaft 116 while rotor 112 remains installed within turbine casing 110. Regardless of whether rotor 112 is removed from turbine casing 110, there is no need for rotor 112 to be rotated during inspection using system 400. Inspection system 400 scans rotor shaft 116 by moving each inspection probe along a circumferential path around shaft outer surface 128 at one of a plurality of axial stations of shaft 116. As used herein, the term “axial station” corresponds to a cross-sectional portion of shaft 116, taken perpendicular to shaft axis 120 (shown in FIG. 1).

In the exemplary embodiment, inspection system 400 includes at least one housing 402. Each housing 402 includes at least one probe 406 operable to inspect shaft 116. More specifically, probe 406 is positioned adjacent a surface 404 of housing 402 adjacent shaft 116, such that probe 406 is positionable against shaft 116. In the exemplary embodiment, each probe 406 includes an ultrasonic transducer (UT). For example, each probe 406 includes a suitable phased array UT transducer having a plurality of separately controllable elements. For another example, each probe 406 includes a single UT element. In alternative embodiments, each probe 406 is any suitable probe that enables system 400 to function as described herein.

In the exemplary embodiment, system 400 includes a pair of housings 402 configured to selectively operate probes 406 in a pitch-catch configuration, in which probe 406 of one housing 402 transmits a signal into shaft 116, and probe 406 of the other housing 402 receives a reflection of the signal from a discontinuity or other structurally weakened area within an interior of shaft 116. Suitable processing of the signals to precisely locate flaws within shaft 116 requires probes 406, and thus housings 402, to be precisely positioned relative to shaft 116, for example within a first tolerance. Moreover, suitable processing of the signals to precisely locate flaws within shaft 116 requires probes 406, and thus housings 402, to maintain precise positioning with respect to each other, for example within a second tolerance, while probes 406 are active. In addition, in the exemplary embodiment, system 400 is configured to selectively operate probe 406 of at least one housing 402 independently in pulse-echo configuration, in which the single probe 406 transmits a signal into shaft 116 and receives a reflection of the signal from a discontinuity or other structurally weakened area within the interior of shaft 116. For example, at some axial stations of shaft 116, pitch-catch signal transmission may be blocked by structural features defined in shaft 116 and/or additional features of rotor 112, necessitating a use of pulse-echo instead. Suitable processing of the pulse-echo signals to precisely locate flaws within shaft 116 again requires the single probe 406, and thus the corresponding housing 402, to be precisely positioned relative to shaft 116, for example within a first tolerance. In some embodiments, the first tolerance for operation in pulse-echo configuration differs from the first tolerance in pitch-catch configuration.

Inspection system 400 also includes at least one retention member 408 positionable about at least a portion of a circumference of shaft 116. Each housing 402 is coupled to, and traversable along, at least one retention member 408 at an axial station of shaft 116. More specifically, each housing 402 includes a positioning system 420 that cooperates with at least one retention member 408 to position respective probe 406 circumferentially at each of a series of indexed, discrete locations with respect to shaft outer surface 128. System 400 is configured to activate probe 406 to scan the corresponding interior region of shaft 116 while housing 402 is stopped at each indexed circumferential location. System 400 facilitates maintaining a position of each probe 406 to within the required tolerance at each indexed circumferential location, and thus facilitates accurate identification of a location of structural weaknesses within shaft 116, without any need for continuous scanning and/or rotation of shaft 116 during inspection.

Each retention member 408 is positioned circumferentially around shaft outer surface 128 at a respective axial station of shaft 116 selected to facilitate inspection of a corresponding interior region of shaft 116. For example, in the embodiment illustrated in FIG. 2, a pair of retention members 408 are positioned in proximity to a single axial station, although axially spaced from each other to accommodate a width of housings 402. Thus, probes 406 of pair of housings 402 are selectively operable in pitch-catch configuration to inspect an interior region of shaft 116 proximate to the selected axial station. Alternatively, the pair of retention members 408 are positioned respectively at two separate axial stations. Thus, probes 406 of pair of housings 402 are selectively operable in pitch-catch configuration to inspect an interior region of shaft 116 located intermediate the two axial stations at which retention members 408 are respectively located. For example, positioning the pair of retention members 408 at two separate axial stations facilitates pitch-catch inspection of an interior region of shaft 116 proximate to an intermediate axial station at which features of shaft 116 and/or rotor 112 prevent direct coupling of retention member 408. Additionally, or alternatively, probe 406 of at least one housing 402 is selectively operable in pulse-echo configuration to inspect an interior region of shaft 116 proximate to the axial station at which the corresponding retention member 408 is positioned. For example, operating a single probe 406 in pulse-echo configuration facilitates inspection of axial stations of shaft 116 at which pitch-catch signal transmission may be blocked by features of shaft 116 and/or rotor 112.

In first embodiment 200 of inspection system 400, the at least one retention member 408 is at least one belt loop 208, and positioning system 420 is embodied as a respective wheel system 220 coupled to each housing 402. Each wheel system 220 cooperates with a respective belt loop 208. In FIG. 3, a face of housing 402 is rendered transparent to show portions of wheel system 220 and belt loop 208 within housing 402.

In the exemplary embodiment, each belt loop 208 is formed from a belt strip adjustably coupled to itself and tightened to form a loop corresponding approximately to the circumference of shaft outer surface 128. Thus, belt loops 208 are adjustable to couple to shafts 116 having a range of diameters. In certain embodiments, remaining slack in each belt loop 208 is taken up by wheel system 220, as will be described herein.

Wheel system 220 is operable to automatically traverse each housing 402, including respective probe 406, along the corresponding belt loop 208. For example, in the exemplary embodiment, each wheel system 220 includes a plurality of wheels 210 that engage the corresponding belt loop 208. At least one wheel 210, designated as driving wheel 212, drivingly engages with belt loop 208, such that a preselected amount of rotation of the at least one driving wheel 212 traverses housing 402 a corresponding preselected distance along belt loop 208 and, thus, a preselected distance along the circumference of shaft outer surface 128. In alternative embodiments, wheel system 220 is operable to automatically traverse each housing 402 along the corresponding belt loop 208 in any suitable fashion that enables system 400 to function as described herein.

Moreover, in the exemplary embodiment, the at least one driving wheel 212 is operably coupled to a suitable controller 202, located for example within housing 402. Controller 202 is configured to command rotation of the at least one driving wheel 212, and to receive feedback from the at least one driving wheel 212 regarding an amount of rotation of, and thus a distance traveled by, the at least one driving wheel 212. More specifically, controller 202 is configured to automatically traverse housing 402 along belt loop 208 to the series of indexed circumferential inspection locations along shaft outer surface 128 to within the first tolerance. In some embodiments, controller 202 is further configured to receive commands from, and/or provide data to, an operator interface (not shown), such as, but not limited to, in real time.

In the exemplary embodiment, controller 202 also is operably coupled to probe 406, such that controller 202 is operable to automatically activate and deactivate probe 406 at each circumferential inspection location. In alternative embodiments, controller 202 is configured to activate probe 406 in response to a user command.

In some embodiments, wheel system 220 facilitates movement of housing 402 along belt loop 208 without slippage of the at least one driving wheel 212 with respect to belt loop 208, and without slippage of belt loop 208 with respect to shaft outer surface 128. For example, a pair of wheels 210, designated tensioning wheels 214, are configured to engage belt loop 208 and drivingly rotate oppositely to each other, such that slack in belt loop 208 around outer surface 128 is taken up by tensioning wheels 214. More specifically, slack is taken up until resistance from belt loop 208 indicates a preselected tension is being maintained in belt loop 208. The preselected tension is sufficient to inhibit slippage of the at least one driving wheel 212 with respect to belt loop 208, and to inhibit slippage of belt loop 208 with respect to shaft outer surface 128.

In certain embodiments, controller 202 is operably coupled to tensioning wheels 214, such that controller 202 is operable to drive tensioning wheels 214 to automatically maintain the preselected tension in belt loop 208. Additionally, or alternatively, at least one wheel 210 is biased against belt loop 208, such by a mechanical spring coupled between the at least one wheel 210 and housing 402, to facilitate maintaining the preselected tension in belt loop 208. In alternative embodiments, wheel system 220 inhibits slippage of the at least one driving wheel 212 with respect to belt loop 208, and/or slippage of belt loop 208 with respect to shaft outer surface 128, in any suitable fashion that enables system 400 to function as described herein.

In certain embodiments, additional wheels 209 that do not engage belt loop 208 are coupled to housing bottom surface 404 to facilitate travel of housing 402 along shaft outer surface 128.

In some embodiments, an accuracy of inspection by probes 406 further depends upon a preselected pressure of probes 406 against shaft outer surface 128 being maintained while probes 406 are active. For example, each probe 406 must be positioned against shaft outer surface 128 at the preselected pressure to facilitate acoustic coupling between probes 406 and shaft 116 during inspection. In certain embodiments, wheel system 220 facilitates maintaining probe 406 in contact with shaft outer surface 128 at the preselected pressure during an inspection, by maintaining the preselected tension in belt loop 208 such that housing 402, and thus probe 406 adjacent bottom surface 404 of housing 402, is urged towards shaft outer surface 128. Additionally, or alternatively, the preselected pressure of probe 406 against shaft outer surface 128 is maintained by a mechanical spring coupled between probe 406 and housing 402, or in any other suitable fashion that enables inspection system 400 to function as described herein.

In some embodiments, first embodiment 200 of system 400 further includes a housing link 418 coupled between housings 402. Housing link 418 facilitates maintaining a relative position between probes 406 to within the second tolerance while probes 406 are active. For example, housing link 418 is a rigid mechanical member that couples pair of housings 402 together at a fixed spacing. In some embodiments, housing link 418 also may be used as a handle to carry housings 402 and/or position housings 402 with respect to shaft 116 during set-up of system 400. Additionally, or alternatively, positioning system 420 facilitates maintaining probes 406 in position relative to each other to within the second tolerance, simultaneously with positioning each probe 406 with respect to shaft outer surface 128 to within the first tolerance, as described above. Additionally, or alternatively, a circumferential position of each probe 406 relative to shaft 116, and/or a relative position of probes 406, is determined and/or maintained by controller 202 at least partially using feedback from additional sensors, such as from respective inclinometers (not shown) coupled to each housing 402.

In the exemplary embodiment, inspection system 400 also includes at least one axially extending spacer arm 419 coupled to at least one housing 402. Spacer arm 419 is configured to bear against a portion of rotor 112, such as but not limited to packing teeth or a rotor wheel face (not shown), that is axially adjacent to the axial station of shaft 116 being inspected, to further facilitate maintaining housings 402 at the axial station during movement along belt loop 208 between circumferential inspection locations. Alternatively, spacer arm 419 is configured to bear against an inspection guide surface (not shown) coupled to shaft 116 axially adjacent to the axial station of shaft 116 being inspected. In alternative embodiments, inspection system 400 does not include spacer arm 419.

First embodiment 200 of inspection system 400 is portable, light weight, and relatively easy to set-up such that the inspection of rotor shaft 116, for example, can be performed by only one operator, and with no need to rotate shaft 116. Additionally, inspection system 400 need only be configured once initially at each axial station to perform an automatic inspection of the regions of shaft 116 corresponding to the entire axial station. As such, the operator is not required to continuously interact with and/or monitor inspection system 400 during inspection of each axial station, thus increasing a speed of the inspection process. Inspection system 400 also facilitates reduction or elimination of errors which may occur as the result of repeated manual positioning at each station during an inspection. Furthermore, wheel system 220 in cooperation with belt loop 208 accommodates a range of diameters of shaft 116, without any need to measure or otherwise predetermine the diameter. Moreover, belt loop 208 can be easily manipulated, lifted, and flexed over rotor shaft 116 by a single operator, even at, for example, elevated working heights.

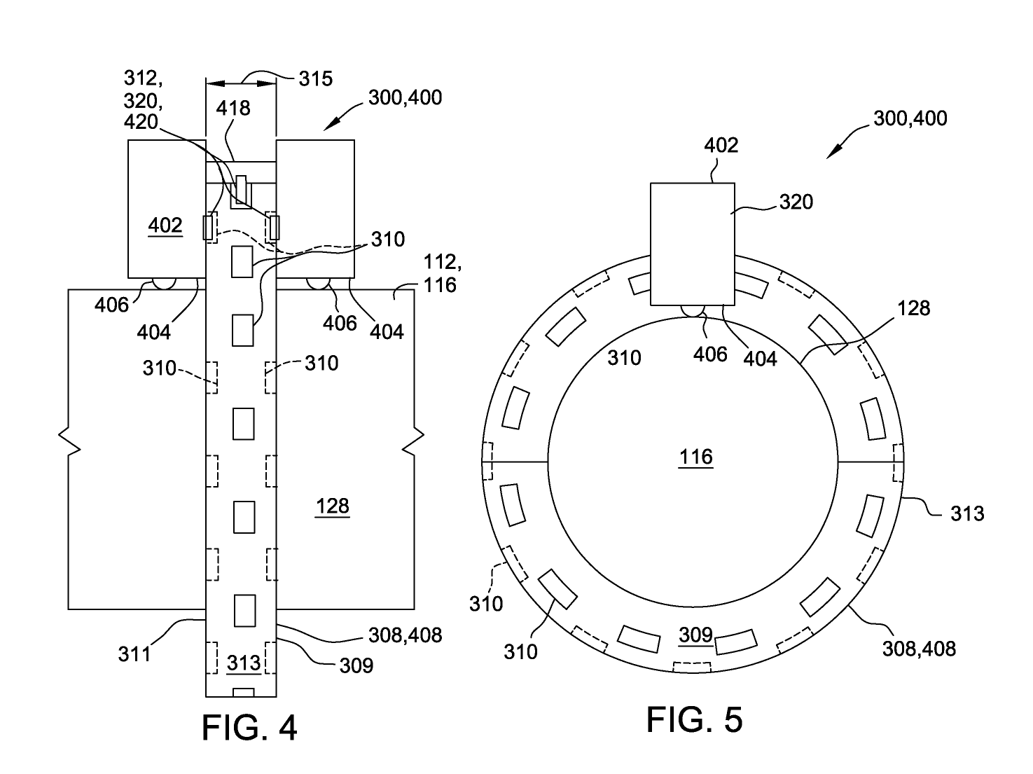

FIG. 4 is a schematic illustration of a second embodiment 300 of inspection system 400 that may be used to inspect a rotor. More specifically, FIG. 4 illustrates a side view of shaft 116 having system 400 coupled thereto. FIG. 5 is a schematic illustration of second embodiment 300 of inspection system 400 taken along axis 120 (shown in FIG. 1) of shaft 116. In the exemplary embodiment, second embodiment 300 of inspection system 400 again includes at least one housing 402, and each housing 402 again includes at least one probe 406 positioned adjacent bottom surface 404 and operable to inspect shaft 116, as described above. However, the at least one retention member 408 is implemented as at least one strong-back 308, and positioning system 420 is implemented as an indexing system 320.

Each strong-back 308 is a rigid structure that extends circumferentially around at least a portion of shaft outer surface 128 at a selected axial station of shaft 116 selected to facilitate inspection of a corresponding interior region of shaft 116. In the exemplary embodiment, each strong-back 308 includes two semicircular portions coupled together to facilitate coupling strong-back 308 around shaft 116. In alternative embodiments, strong-back 308 is formed in any suitable fashion that enables second embodiment 300 of system 400 to function as described herein. At least one housing 402 is coupled to each strong-back 308 and is circumferentially traversable along strong-back 308. More specifically, indexing system 320 is configured to retain housing 402 at each of a series of indexed circumferential inspection locations along strong-back 308, and thus along the circumference of shaft outer surface 128, to within the first tolerance.

For example, in the embodiment illustrated in FIG. 4, the at least one retention member is a single strong-back 308 positioned in proximity to a single axial station, and a pair of housings 402 are positionable on opposite sides of strong-back 308. Thus, probes 406 of pair of housings 402 are selectively operable in pitch-catch configuration to inspect an interior region of shaft 116 proximate to the selected axial station. Alternatively, the at least one retention member 408 is a pair of strong-backs 308 positioned respectively at two separate axial stations (second strong-back 308 not shown), and each of the pair of strong-backs 308 has one of a pair of housings 402 coupled thereto. Thus, probes 406 of pair of housings 402 are selectively operable in pitch-catch configuration to inspect an interior region of shaft 116 located intermediate the two axial stations at which retention members 408 are respectively located. For example, positioning the pair of retention members 408 at two separate axial stations facilitates pitch-catch inspection of an interior region of shaft 116 proximate an intermediate axial station at which features of shaft 116 and/or rotor 112 prevent direct coupling of retention member 408. Additionally, or alternatively, probe 406 of at least one housing 402 is selectively operable in pulse-echo configuration to inspect an interior region of shaft 116 proximate to the axial station at which the corresponding retention member 408 is positioned. For example, operating a single probe 406 in pulse-echo configuration facilitates inspection of axial stations of shaft 116 at which pitch-catch signal transmission may be blocked by features of shaft 116 and/or rotor 112.

In certain embodiments, indexing system 320 is actuatable to releasably retain the respective housing 402 at each circumferential inspection location. In the exemplary embodiment, indexing system 320 cooperates with a plurality of notches 310 defined on strong-back 308. More specifically, notches 310 are spaced circumferentially around strong-back 308, and each notch 310 corresponds to a preselected circumferential inspection location around shaft 116. Indexing system 320 includes an actuatable projection 312 configured to be received by each of notches 310 to lock each housing 402, and thus each probe 406, at the corresponding circumferential location to within the first tolerance. Moreover, projection 312 is retractable, such as by manual operation of a suitable trigger mechanism (not shown) on housing 402 or housing link 418, to disengage from notch 310 after completion of probe activation, such that housings 402 may be advanced to the next notch location.

In some embodiments, plurality of notches 310 includes pairs of notches 310 circumferentially spaced around strong-back 308 on opposing surfaces 309 and 311 of strong-back 308, and indexing system 320 of each housing 402 includes a respective actuatable projection 312 configured to be received by one of each pair of notches 310. Thus, each housing 402 locks separately to, and is separately releasable from, strong-back 308. In other embodiments, plurality of notches 310 includes notches 310 circumferentially spaced around a radially outer surface 313 of strong-back 308, and indexing system 320 is a single actuatable projection 312 coupled to housing link 418. Thus, housings 402 lock, and are releasable from, strong-back 308 together as a pair. Although notches 310 and indexing system 320 are shown in both locations in FIGS. 3 and 4 for purposes of illustration, it should be understood that each embodiment may be implemented separately. Alternatively, notches 310 could be provided in housings 402 and projections 312 could be provided on strong-back 308. Alternatively, indexing system 320 is configured to cooperate with any suitable indexing features on strong-back 308, such as, but not limited to, protrusions, sprocket teeth or ridges, cutouts, divots, or the like.

In certain embodiments, strong-back 308 does not include notches 310, and indexing system 320 is configured to couple housings 402 directly to at least one of surfaces 309, 311, and 313 of strong-back 308. For example, indexing system 320 is actuatable to reduce an axial spacing 315 between pair of housings 402 coupled to a single strong-back 308, such that housings 402 securely couple against opposing surfaces 309 and 311 in a friction fit when indexing system 320 is actuated. For another example, indexing system 320 securely couples to at least one of surfaces 309, 311, and 313 using magnetism. For another example, indexing system 320 securely couples to at least one of surfaces 309, 311, and 313 using vacuum suction.

In some embodiments, indexing system 320 includes an encoder (not shown), such as on bottom surface 404 of housing 402, such that a circumferential location of housings 402 along shaft 116 is trackable by indexing system 320 as housings 402 are moved along strong-back 308. Additionally, or alternatively, at least one of surfaces 309, 311, and 313 includes precisely located tracking features, such as inscribed lines (not shown), and each housing 402 includes a sensor (not shown) to detect movement past the tracking features, such that a circumferential location of housings 402 along shaft 116 is trackable by indexing system 320 as housings 402 are moved along strong-back 308.

In the exemplary embodiment, housing link 418 again facilitates maintaining a relative circumferential position between probes 406 to within the second tolerance while probes 406 are active, as described above. Additionally, or alternatively, a relative position of probes 406 is again determined at least partially using feedback from additional sensors, such as inclinometers (not shown) coupled to each housing 402.

In alternative embodiments, indexing system 320 includes any suitable structure that enables second embodiment 300 of system 400 to function as described herein.

In the exemplary embodiment, each strong-back 308 is positioned with respect to a datum (not shown) on rotor 112 that defines a coordinate system of rotor 112. Thus, a position of housings 402, and therefore probes 406, at each location on each strong-back 308 is translatable to a position with respect to the rotor coordinate system. In alternative embodiments, a position of probes 406 at each location may be translated to the rotor coordinate system in any suitable fashion.

In the exemplary embodiment, housings 402, strong-backs 308, and indexing system 320 are sized and configured such that the preselected pressure of probe 406 against shaft outer surface 128 is maintained when housings 402 are locked at each circumferential inspection location. Moreover, in certain embodiments, a radial position of each housing 402 with respect to strong-back 308 is adjustable, such that housings 402 in cooperation with strong-back 308 accommodate a range of diameters of shaft 116, without any need to measure or otherwise predetermine the diameter. Additionally, or alternatively, the preselected pressure of probe 406 against shaft outer surface 128 is maintained by a mechanical spring coupled between probe 406 and housing 402, or in any other suitable fashion that enables inspection system 400 to function as described herein.

In some embodiments, each housing 402 is configured to be retained by strong-back 308 during circumferential traversal along strong-back 308 between each circumferential inspection location. For example, strong-back 308 includes circumferentially extending grooves (not shown) defined in surfaces 309 and/or 311, and each housing 402 includes a tongue (not shown) configured for retention in the groove. For another example, strong-back 308 includes a circumferentially extending groove (not shown) defined in radially outer surface 313, and housing link 418 includes a tongue (not shown) configured for retention in the groove. For another example, each housing 402 includes a magnetic portion that facilitates retaining housings 402 on strong-back 308. In other embodiments, pair of housings 402 is not configured to be retained by strong-back 308 during traversal between circumferential inspection locations. For example, housings 402 are solely manually supported during traversal between the circumferential inspection locations.

Second embodiment 300 of inspection system 400 is portable, light weight, and relatively easy to set-up, and the inspection of rotor shaft 116, for example, can be performed by only one operator, with no need to rotate shaft 116. Additionally, inspection system 400 need only be configured once initially at each axial station to perform an inspection of the regions of shaft 116 corresponding to the entire axial station. As such, the operator is not required to continuously interact with and/or monitor inspection system 400 during inspection, thus increasing a speed of the inspection process. Inspection system 400 also facilitates reduction or elimination of errors which may occur as the result of repeated manual positioning at each station during an inspection. Moreover, in certain embodiments, housings 402 in cooperation with strong-back 308 accommodate a range of diameters of shaft 116, without any need to measure or otherwise predetermine the diameter. Furthermore, second embodiment 300 requires fewer motorized components and less complex control features than first embodiment 200 of inspection system 400.

Some embodiments involve the use of one or more electronic or computing devices, such as controller 202. Such devices typically include a processing device such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by the controller or processing device, cause the controller or processing device to perform at least some of the method steps described herein. The above examples are exemplary only, and thus are not intended to limit in any way the definition and/or meaning of the terms controller and processing device.

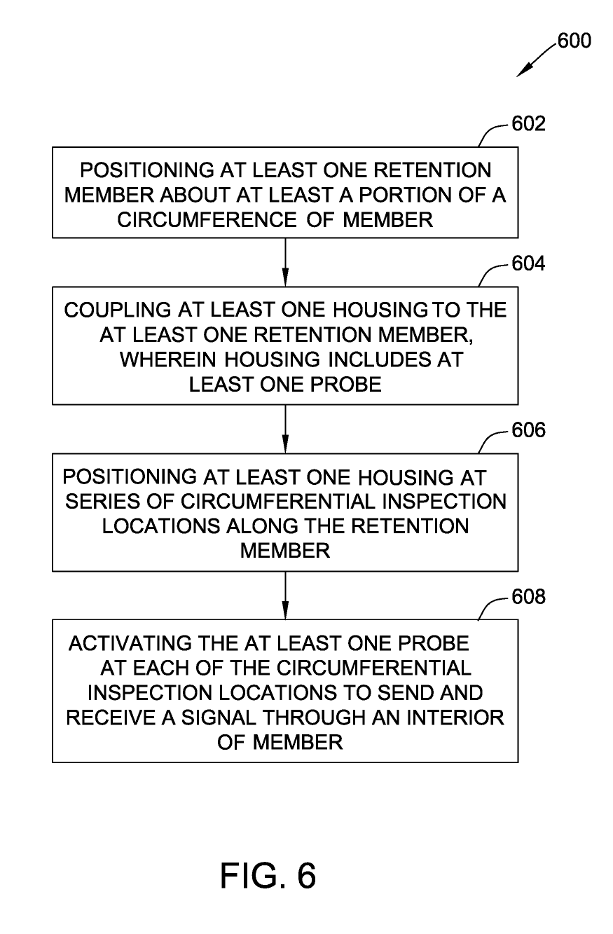

FIG. 6 is a flow diagram of an exemplary method 600 of inspecting a cylindrical member, such as rotor shaft 116 (shown in FIG. 1). With reference also to FIGS. 2-5, in the exemplary embodiment, method 600 includes positioning 602 at least one retention member 408 about at least a portion of a circumference of the cylindrical member, and coupling 604 at least one housing 402 to the at least one retention member. The at least one housing includes at least one probe 406. Method 600 also includes positioning 606 the at least one housing at a series of circumferential inspection locations along the retention member, and activating 608 the at least one probe at each of the circumferential inspection locations to send and receive a signal through an interior of the cylindrical member. For example, but not by way of limitation, the at least one housing includes a pair of housings, and step 608 includes activating the at least one probe of one of the housings and the at least one probe of another of the housings at each of the circumferential inspection locations to respectively send and receive the signal through the interior of the cylindrical member in a pitch-catch configuration.

Embodiments of the systems and methods described herein for inspecting a cylindrical member, such as, for example, a turbine rotor shaft, provide advantages over at least some known systems and methods for inspecting cylindrical members. For example, the embodiments described herein facilitate non-invasive inspection of a cylindrical member from around the outer circumference of the cylindrical member, without any need to rotate the cylindrical member. Specifically, the embodiments described herein facilitate positioning of at least one inspection probe at a series of indexed circumferential inspection locations around the cylindrical member, thereby reducing a need for manual positioning of the probe at each circumferential location, which reduces a time required for, and a potential for errors in, probe positioning. Also, specifically, the embodiments described herein facilitate an ease of transportation and initial set-up of the inspection system. Thus, the embodiments described herein facilitate reducing the number for people required to set up the system and perform the inspection. For example, in some embodiments, only one operator is required. Further, in some embodiments, the probe is automatically traversed around the cylindrical member without manual intervention after the initial set-up. The embodiments thus facilitate reducing an amount of time associated with an inspection, which for example reduces a cost associated with inspecting a rotor of a turbine. In some cases, the embodiments described herein reduce an amount of revenue lost by a power plant because of a turbine rotor inspection process.

Exemplary embodiments of cylindrical member inspection systems and methods are described above in detail. The systems and methods described herein are not limited to the specific embodiments described herein, but rather, components of the systems and methods may be utilized independently and separately from other components described herein. For example, the systems and methods described herein may have other applications not limited to practice with turbines, as described herein. Rather, the systems and methods described herein can be implemented and utilized in connection with various other industries.

While the disclosure has been described in terms of various specific embodiments, those skilled in the art will recognize that the disclosure can be practiced with modification within the spirit and scope of the claims.

What is claimed is:

1. An inspection system for a cylindrical member, said inspection system comprising:
at least one retention member positionable about at least a portion of a circumference of the cylindrical member;
a positioning system; and
at least one housing coupleable to said at least one retention member at each of a series of circumferential inspection locations, said at least one housing comprising at least one probe, wherein said positioning system cooperates with said at least one retention member to position said at least one probe at each of the circumferential locations, and wherein said at least one probe is configured to send and receive a signal through an interior of the cylindrical member.

2. The system of claim 1, wherein said at least one housing comprises a pair of housings, said system further comprising a housing link coupled between said pair of housings.

3. The system of claim 1, wherein said at least one probe is an ultrasonic probe, said housing is configured to position said at least one probe against an outer surface of the cylindrical member at a preselected pressure that facilitates acoustic coupling between said at least one probe and the cylindrical member.

4. The system of claim 1, wherein said at least one retention member comprises at least one belt loop, and said positioning system comprises a wheel system coupled to said at least one housing, said wheel system operable to automatically traverse said at least one housing along said at least one belt loop.

5. The system of claim 4, wherein said wheel system comprises at least one driving wheel that drivingly engages said belt loop, such that a preselected amount of rotation of said at least one driving wheel moves said at least one housing a corresponding preselected distance along a circumference of the outer surface.

6. The system of claim 5, further comprising a controller operably coupled to said at least one driving wheel and configured to automatically traverse said at least one housing along said belt loop to each of the circumferential inspection locations.

7. The system of claim 6, wherein said controller is further configured to automatically activate said at least one probe at each of the circumferential inspection locations.

8. The system of claim 4, wherein said wheel system comprises a pair of tensioning wheels configured to engage said belt loop and drivingly rotate oppositely to each other, such that slack in said belt loop is taken up by said tensioning wheels.

9. The system of claim 8, further comprising a controller operably coupled to said pair of tensioning wheels and configured to maintain a preselected tension in said belt loop.

10. The system of claim 1, wherein said at least one retention member comprises at least one strong-back, and said positioning system comprises an indexing system configured to retain said at least one housing at each of the series of circumferential inspection locations along said strong-back.

11. The system of claim 10, wherein said indexing system comprises at least one actuatable projection.

12. The system of claim 11, wherein said strong-back comprises a plurality of notches defined therein and configured to cooperate with said at least one actuatable projection to releasably retain said at least one housing at each of the circumferential inspection locations.

13. The system of claim 11, wherein said indexing system is configured to couple said housings directly to said strong-back using at least one of a friction fit, magnetism, and vacuum suction.

14. The system of claim 10, wherein said at least one strong-back comprises two semicircular portions coupleable together around the cylindrical member.

15. A method of inspecting a cylindrical member, said method comprising:
positioning at least one retention member about at least a portion of a circumference of the cylindrical member;
coupling at least one housing to the at least one retention member, wherein the at least one housing includes at least one probe;
positioning the at least one housing at a series of circumferential inspection locations along the retention member; and
activating the at least one probe at each of the circumferential inspection locations to send and receive a signal through an interior of the cylindrical member.

16. The method of claim 15, wherein the at least one probe is an ultrasonic probe, said method further comprising positioning the at least one probe against an outer surface of the cylindrical member at a preselected pressure that facilitates acoustic coupling between the at least one probe and the cylindrical member.

17. The method of claim 15, wherein said positioning the at least one retention member comprises positioning at least one belt loop about the circumference of the cylindrical member.

18. The method of claim 17, wherein said positioning the at least one housing comprises automatically traversing the at least one housing along the belt loop using a wheel system coupled to the at least one housing.

19. The method of claim 15, wherein said positioning the at least one retention member comprises positioning at least one strong-back about the circumference of the cylindrical member.

20. The method of claim 19, wherein said positioning the at least one housing comprises actuating an indexing system to retain the at least one housing at each of the circumferential inspection locations.
